(19) United States
(12) Patent Application Publication
(10) Pub. No.: US 2016/0118857 A1
(43) Pub. Date: Apr. 28, 2016

(54) COOLING UNIT OF DRIVE MOTOR

(71) Applicant: HYUNDAI MOTOR COMPANY, Seoul (KR)

(72) Inventors: Myung Kyu Jeong, Seoul (KR); Young Jin Seo, Yongin (KR); Dongyeon Han, Seoul (KR)

(21) Appl. No.: 14/749,065

(22) Filed: Jun. 24, 2015

(30) Foreign Application Priority Data
Oct. 28, 2014 (KR) 10-2014-0147704

(51) Int. Cl. H02K 5/20

(52) U.S. Cl. CPC H02K 5/20

(57) ABSTRACT

A cooling unit of a drive motor for cooling a stator of the drive motor includes a guide path disposed between an inner side of a motor housing and an outer side of the stator forming a flow path through which coolant repeatedly flows in an axial direction of the stator.

### CROSS-REFERENCE TO RELATED APPLICATION

This application claims priority to and the benefit of Korean Patent Application No. 10-2014-0147704 filed in the Korean Intellectual Property Office on Oct. 28, 2014, the entire contents of which are incorporated herein by reference.

### BACKGROUND OF THE DISCLOSURE

(a) Technical Field

The present disclosure relates generally to a drive motor for an environmentally friendly vehicle, and more particularly, to a cooling unit of a drive motor for cooling heat generated from a stator of the drive motor.

(b) Description of the Related Art

In general, a hybrid vehicle or an electric vehicle may generate driving torque through use of an electric motor (hereinafter referred to as “drive motor”) which obtains driving torque from electrical energy. For example, a hybrid vehicle travels in an electric vehicle (EV) mode, which is a pure electric vehicle mode using only power from the drive motor, or travels in a hybrid electric vehicle (HEV) mode using both torque of an engine and torque of the drive motor as power. Further, an electric vehicle travels using torque from the drive motor as the power.

The drive motor typically includes a stator and a rotor. The stator is coupled in a motor housing, and the rotor is spaced apart from an inner side of the stator. The stator includes a stator core made of an electric steel plate and a coil wound around the stator core. A large amount of heat is generated according to a current (AC) applied to the coil. An eddy current is generated in a stator core based on the current, and a reverse voltage due to change of a magnetic flux generated from a rotated magnet.

Accordingly, in the drive motor mounted in a hybrid vehicle, since a large amount of heat is generated in a stator core due to the current, cooling should be substantially performed in order to prevent damage due to the heat and to continuously ensure stable operability. A technique for cooling the drive motor includes an oil cooling scheme using transmission oil and a water cooling scheme using cooling water in a hybrid vehicle where a motor is fixed inside a transmission. For example, in a cooling unit of a drive motor using the water cooling scheme, a coolant flow path is formed between an outer side of a stator and an inner side of a motor housing, and a coolant flows in the flow path so that heat generated from the stator may be cooled by the coolant.

In the conventional cooling unit, as described above, a protrusion is formed at an outer side of the stator to reduce a flow rate of the coolant to be supplied to a coolant flow path by a dead weight through a coolant supply part provided at an upper portion of a motor housing. Accordingly, the flow rate of the coolant may be reduced by reducing the size of a gap of a coolant flow path formed between the stator and the motor housing through a protrusion at an outer side of the stator. However, in this case, since the cooling flow path has an annular shape (depending on an outer side of a stator between an outer side of the stator and an inner side of the motor housing), a length of the coolant flow path is limited to 2 [symbol] r (r: radius of the stator) so that a contact time between the stator and the coolant may be reduced.

The above information disclosed in this Background section is only for enhancement of understanding of the background of the disclosure, and therefore, it may contain information that does not form the related art that is already known in this country to a person of ordinary skill in the art.

### SUMMARY OF THE DISCLOSURE

The present disclosure has been made in an effort to provide a cooling unit of a drive motor having advantages of reducing a flow rate of a coolant circulating between an inner side of a motor housing and an outer side of a stator, and increasing a contact time of the coolant with the stator. Embodiments of the present disclosure provide a cooling unit of a drive motor for cooling a stator of the drive motor includes a guide path disposed between an inner side of a motor housing and an outer side of the stator forming a flow path through which coolant repeatedly flows in an axial direction of the stator.

The guide path may be therein with a plurality of steps in the axial direction of the stator.

The guide path may be formed with a plurality of first steps to guide the coolant downward from an upper portion of the stator and a plurality of second steps to guide the coolant upward from a lower portion of the stator.

The guide path may form a connection passage between the plurality of first steps and the plurality of second steps.

The guide path may form a zigzag-like flow path in the axial direction of the stator.

The guide path may form a serpentine-like flow path in the axial direction of the stator.

The guide path may include an integral protrusion that protrudes to the outer side of the stator and adheres closely to the inner side of the motor housing.

The guide path may include an integral protrusion that protrudes to the inner side of the motor housing and adheres closely to the outer side of the stator.

The guide path may be separately disposed between the inner side of the motor housing and the outer side of the stator and may adhere closely to the inner side of the motor housing and the outer side of the stator.

### BRIEF DESCRIPTION OF THE DRAWINGS

FIG. 1 is a perspective view illustrating a cooling unit of a drive motor according to embodiments of the present disclosure.

FIG. 2 is a plan view illustrating a cooling unit of a drive motor according to embodiments of the present disclosure.

FIG. 3 is a partially cut-away perspective view illustrating a cooling unit of a drive motor according to embodiments of the present disclosure.

FIG. 4 is a view illustrating a modified example of a cooling unit of a drive motor according to embodiments of the present disclosure.

FIG. 5 is a view illustrating another modified example of a cooling unit of a drive motor according to embodiments of the present disclosure.

<Description of symbols>

| | |
|---|---|
| 1 . . . motor housing | 3 . . . stator |
| 4 . . . stator core | 5 . . . rotor |
| 10, 110, 210 . . . guide path | 11, 111, 211 . . . unit guide |
| 21 . . . flow path | 31 . . . first step |
| 32 . . . second step | 35 . . . connection passage |

### DETAILED DESCRIPTION OF THE EMBODIMENTS

Hereinafter, exemplary embodiments of the present disclosure will be described in detail with reference to the accompanying drawings. As those skilled in the art would realize, the described embodiments may be modified in various different ways, all without departing from the spirit or scope of the present disclosure. Further, throughout the specification, like reference numerals refer to like elements.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

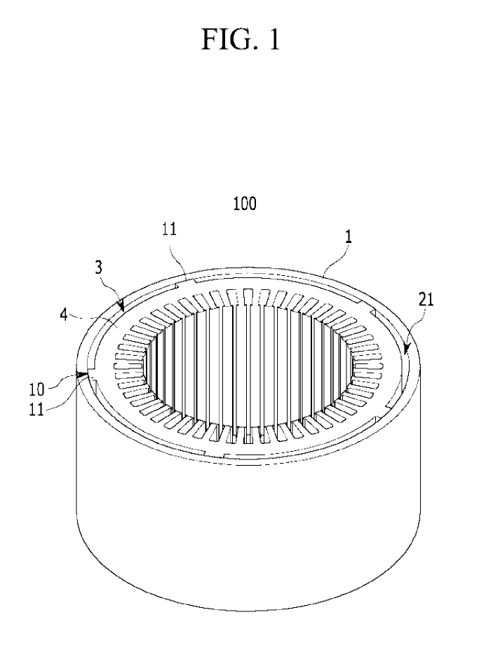

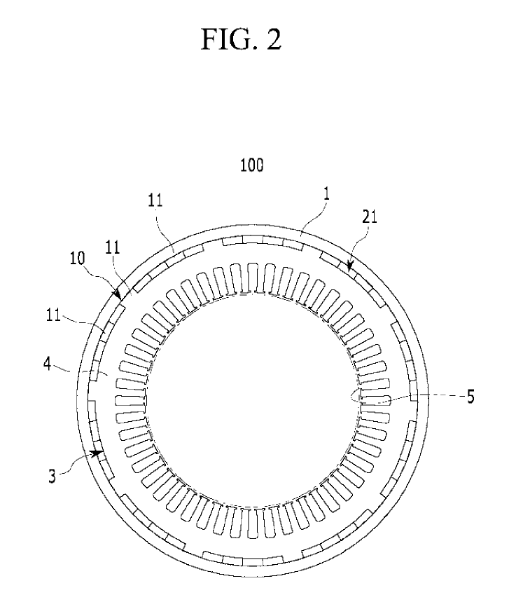

Referring now to the disclosed embodiments, FIG. 1 is a perspective view illustrating a cooling unit of a drive motor according to embodiments of the present disclosure, and FIG. 2 is a plan view illustrating a cooling unit of a drive motor according to embodiments of the present disclosure.

As shown in FIG. 1 and FIG. 2, the cooling unit 100 of a drive motor is applicable to a drive motor (e.g., electric motor) to obtain driving torque through electrical energy in an environmentally friendly vehicle such as a hybrid vehicle. For example, the drive motor may include a motor housing 1, a stator 3 installed inside the motor housing 1, and a rotor 5 installed at an inner side of the stator 3 to be spaced apart from the stator 3 by a predetermined gap.

The stator 3 may be configured at a stator core 4 to be wound by a rotor coil (not shown), and the rotor 5 may be configured where a permanent magnet is inserted into a rotor core (not shown) or is wound by a rotor coil (not shown). That is, the present disclosure is applicable to a permanent magnet synchronous motor (PMSM) where a permanent magnet is inserted into a rotor core of the rotor 5, and is applicable to a wound rotor synchronous motor (WRSM) where a rotor coil is wound around the rotor core of the rotor 5. The stator 3 and the rotor 5 are configured as a stator and rotor structure applied to a PMSM or a WRSM generally known in the art, and thus the detailed description is omitted in the specification.

Meanwhile, the cooling unit 100 for radiating heat generated from a stator coil with high integration and high density applied to the stator 3 is used for the above drive motor. The cooling unit 100 cools the stator 3 through a coolant by allowing the coolant to flow between an inner side of the motor housing 1 and an outer side of the stator 3. Accordingly, the cooling unit 100 of the drive motor may circulate a cooling water between the inner side of the motor housing 1 and an outer side of the stator 3 as the coolant, and may indirectly cool heat generated from the stator coil (not shown) through the stator core 4.

The cooling unit 10 of the drive motor to be described below has a structure which may improve cooling efficiency of a drive motor by reducing a flow rate of a coolant circulating between the inner side of the motor housing 1 and the outer side of the stator 3, and increasing a contact time of the coolant with the stator 3.

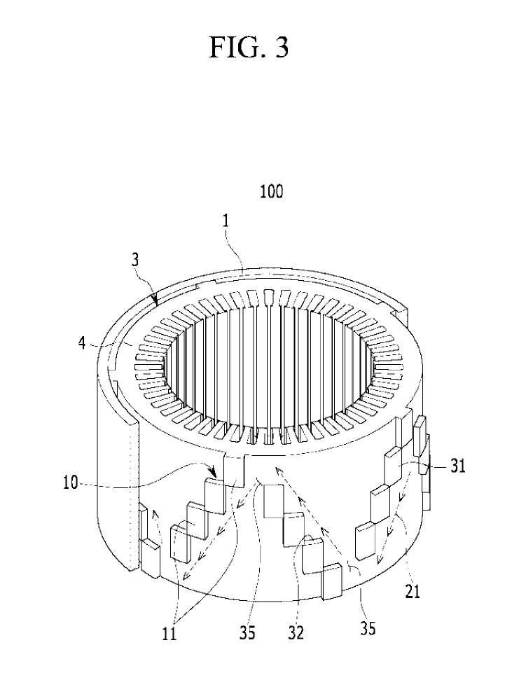

FIG. 3 is a partially cut-away perspective view illustrating a cooling unit of a drive motor according to embodiments of the present disclosure.

As shown in FIG. 1 to FIG. 3, the cooling unit 100 of the drive motor includes a guide path 10 formed therein. The guide path 10 serves to form a flow path 21 (i.e., “cooling path”) between the inner side of the motor housing 1 and the outer side of the stator 3. That is, the guide path 10 may form the flow path 21 of the coolant which repeatedly flows in an axial direction of the stator 3 between the inner side of the motor housing 1 and the outer side of the stator 3. In other words, a region except for the guide path 10 may be formed as the above flow path 21 between the inner side of the motor housing 1 and the outer side of the stator 3.

The guide path 10 is disposed between the inner side of the motor housing 1 and an outer side of the stator 3. For example, the guide path 10 is integrally protruded to the outer side of the stator 3 and may adhere closely to the inner side of the motor housing 1. That is, an integral protrusion of the guide path 10 may protrude to the outer side of the stator 3 and adhere closely to the inner side of the motor housing 1.

In detail, the guide path 10 includes a plurality of unit guides 11 having a curved surface corresponding to the inner side of the motor housing 1. The unit guides 11 continuously protrude to the outer side of the stator 3 in an axial direction of the stator 3. The unit guides 11 of the guide path 10 has a predetermined thickness by laminating a plurality of electric steel plates and may integrally protrude to the outer side of the stator 3. The curved surface of the unit guide 11 may adhere closely to the inner side of the motor housing 1, and may have a curvature corresponding to the outer side of the stator 3 and the inner side of the motor housing 1. The unit guides 11 are continuously stepped downward from an upper portion of the stator 3 in an axial direction, and are continuously stepped upward from a lower portion of the stator 3 in an axial direction. That is, the unit guides 11 may be repeatedly formed downward from the upper portion of the stator and upward from the lower portion of the stator 3 in the axial direction of the stator 3.

Accordingly, the guide path 10 may form a plurality of steps 31 and 32 which repeat in an axial direction of the stator 3 by the unit guides 11, and may configure a flow path 21 of a coolant which repeatedly flows in an axial direction of the stator 3 based on the steps 31 and 32. The plurality of steps 31 and 32 as described above may be divided into a plurality of first steps 31 to guide the coolant downward from the upper portion of the stator 3 in the axial direction between the inner side of the motor housing 1 and the outer side of the stator 3, and a plurality of second steps 32 to guide the coolant upward from the lower portion of the stator 3 in the axial direction between the inner side of the motor housing 1 and the outer side of the stator 3. The first and second steps 31 and 32 may form the flow path 21 to continuously and repeatedly guide the coolant downward from the upper portion of the stator 3 and upward from the lower portion of the stator 3 in the axial direction of the stator 3 between the inner side of the motor housing 1 and the outer side of the stator 3.

Further, the guide path 10 configured by the unit guides 11 forms a connection passage 35 between first and second steps 31 and 32 between the inner side of the motor housing 1 and an outer side of the stator 3. The connection passage 35 is a passage which connects regions (e.g., spaces) divided by the unit guides 11 to each other between the inner side of the motor housing 1 and the outer side of the stator 3. Accordingly, the guide path 10 may form the flow path 21 in a zigzag-like form or in a serpentine-like form in an axial direction of the stator 3 through the first and second steps 31 and 32 of the unit guides 11 between the inner side of the motor housing 1 and an outer side of the stator 3.

In accordance with the cooling unit 100 of the drive motor, since the guide path 10 is provided between the inner side of the motor housing 1 and an outer side of the stator 3, the flow path 21 of a coolant repeatedly flowing in an axial direction of the stator 3 may be formed according to the guide path 10. Accordingly, if the coolant is supplied between the inner side of the motor housing 1 and an outer side of the stator 3, the coolant repeatedly flows in the axial direction of the stator 3 along the flow path 21, and heat generated from the stator coil (not shown) may be indirectly cooled through the stator core 4.

The coolant may repeatedly flow in the axial direction of the stator 3 through the first and second steps 31 and 32 of the unit guides 11, and may flow through the connection passage 35 between the first and second steps 31 and 32. Accordingly, since the guide path 10 is formed between the inner side of the motor housing 1 and the outer side of the stator 3, a length of the flow path 21 in the coolant may be increased, a flow rate of the coolant may be reduced, and the contact time of the coolant with the stator 3 may be further increased. Since the contact time of the coolant with the stator 3 between the inner side of the motor housing 1 and the outer side of the stator 3 is increased, the cooling efficiency of the drive motor may be further improved.

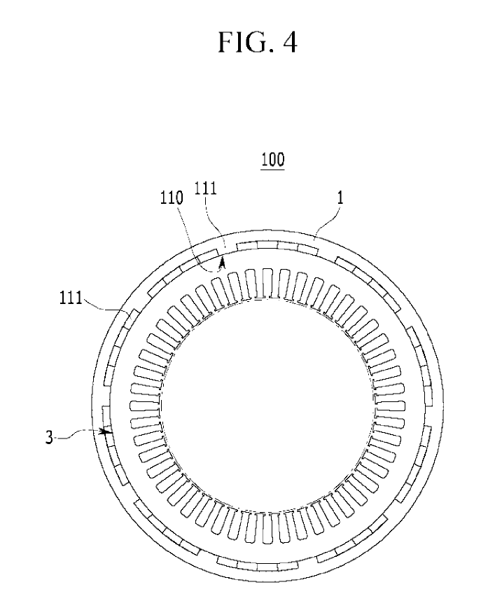

FIG. 4 is a view illustrating a modified example of a cooling unit of a drive motor according to embodiments of the present disclosure.

As shown in FIG. 4, in the modified example of the cooling unit 10 of the drive motor, a guide path 110 may integrally protruded to the inner side of the motor housing 1 and adhere closely to the outer side of the stator 3. That is, an integral protrusion of the guide path 110 may protrude to the inner side of the motor housing 1 and adhere closely to the outer side of the stator 3. The guide path 110 includes a plurality of unit guides 111 having a curved surface corresponding to the outer side of the stator 3. Upon a casting process of the motor housing 1, the unit guides 111 may be integrally formed on the inner side of the motor housing 1. Since the remaining configuration and operational effects of the guide path 110 according to the modified example were described previously, the detailed description thereof is omitted.

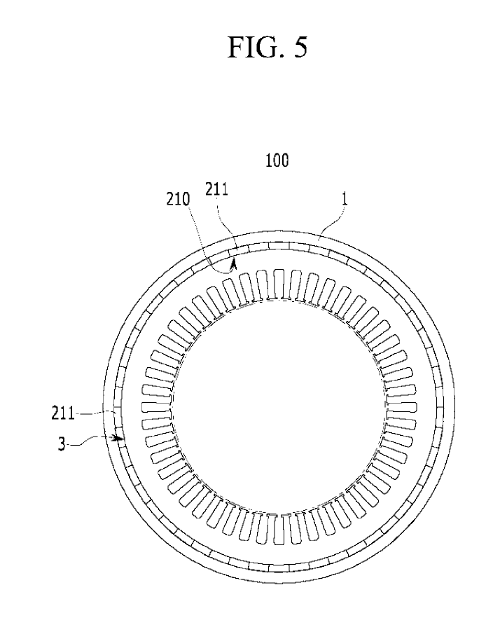

FIG. 5 is a view illustrating another modified example of a cooling unit of a drive motor according to embodiments of the present disclosure.

As shown in FIG. 5, in another modified example of the cooling unit 100 of the drive motor, a guide path 210 may be separately configured between the inner side of the motor housing 1 and the outer side of the stator 3, and may adhere closely to the inner side of the motor housing 1 and the outer side of the stator 3. In this case, the guide path 210 includes a plurality of unit guides 211 including both sides formed therein with curved surfaces corresponding to the inner side of the motor housing 1 and the outer side of the stator 3. For example, the unit guides 211 may be welded to the inner side of the motor housing 1 and the outer side of the stator 3. Since the remaining configuration and operational effects of the guide path 210 according to the modified example were described previously, the detailed description thereof is omitted.

While this disclosure has been described in connection with what is presently considered to be practical embodiments, it is to be understood that the disclosure is not limited to the disclosed embodiments. On the contrary, it is intended to cover various modifications and equivalent arrangements included within the spirit and scope of the appended claims.

What is claimed is:

1. A cooling unit of a drive motor for cooling a stator of the drive motor, the cooling unit comprising:
a guide path disposed between an inner side of a motor housing and an outer side of the stator forming a flow path through which coolant repeatedly flows in an axial direction of the stator.

2. The cooling unit of a drive motor of claim 1, wherein the guide path is formed with a plurality of steps in the axial direction of the stator.

3. The cooling unit of a drive motor of claim 1, wherein the guide path is formed with a plurality of first steps to guide the coolant downward from an upper portion of the stator and a plurality of second steps to guide the coolant upward from a lower portion of the stator.

4. The cooling unit of a drive motor of claim 3, wherein the guide path forms a connection passage between the plurality of first steps and the plurality of second steps.

5. The cooling unit of a drive motor of claim 4, wherein the guide path forms a zigzag-like flow path in the axial direction of the stator.

6. The cooling unit of a drive motor of claim 4, wherein the guide path forms a serpentine-like flow path in the axial direction of the stator.

7. The cooling unit of a drive motor of claim 1, wherein an integral protrusion of the guide path protrudes to the outer side of the stator and adheres closely to the inner side of the motor housing.

8. The cooling unit of a drive motor of claim 1, wherein an integral protrusion of the guide path protrudes to the inner side of the motor housing and adheres closely to the outer side of the stator.

9. The cooling unit of a drive motor of claim 1, wherein the guide path is separately disposed between the inner side of the motor housing and the outer side of the stator and adheres closely to the inner side of the motor housing and the outer side of the stator.
